(19) United States
(12) Patent Application Publication
(10) Pub. No.: US 2025/0221384 A1
(43) Pub. Date: Jul. 10, 2025

(54) Integrated Smart Collar-Based Pet Management and Monitoring System and Related Methods

(71) Applicants: Michael Joseph Boeding, Moberly, MO (US); Kyle Matthew Mauzey, Fayette, MO (US)

(72) Inventors: Michael Joseph Boeding, Moberly, MO (US); Kyle Matthew Mauzey, Fayette, MO (US)

(21) Appl. No.: 18/407,489

(22) Filed: Jan. 9, 2024

(51) Int. Cl. A01K 29/00; A01K 1/01; A01K 1/03; A01K 5/02; A01K 7/02; A01K 11/00; A01K 27/00; G01S 19/07; G07C 9/00

(52) U.S. Cl. CPC A01K 29/005; A01K 11/008; A01K 27/009; G07C 9/00182; G01S 19/07; G07C 2009/0019

(57) ABSTRACT

The present invention relates to a pet management system and a computer-implemented method for enhancing pet care. The system includes a smart collar equipped with a wireless communications module, a rechargeable battery, and a controller. The smart collar is designed to uniquely identify a pet and to facilitate communication with user devices and various peripheral smart pet devices. These peripheral devices provide tailored functionalities to the pet based on stored permissions and authorizations related to the pet's unique identity. The smart collar's controller is configured to continuously monitor and track the pet's interactions with these devices, and to maintain wireless communication with the user's devices. Additionally, the system incorporates a Real Time Kinematic (RTK) base station to enhance the GPS capabilities of the smart collar, providing precise location information for improved pet tracking and management. This invention offers an integrated approach to monitor, control, and manage pet care activities, ensuring an advanced level of care and interaction between pets and their owners.

### FIELD OF INVENTION

The present invention relates generally to the field of pet care and management. Specifically, it relates to a system and method for integrating smart technology with pet accessories for monitoring, managing, and enhancing the care of pets through a network of interconnected devices controlled by a smart collar.

### BACKGROUND

In the field of pet care technology, there has been a significant evolution in recent years, with advancements aimed at improving the lives of pets and their owners. Traditional pet care methods often lack the integration of modern technology, leading to challenges in monitoring and managing the health and safety of pets. The current landscape of pet care devices, while beneficial, often operates in isolation, limiting their effectiveness and the ability to provide comprehensive care.

One of the primary limitations in existing pet care technology is the lack of a centralized system. Pet owners often use multiple, disjointed devices to care for their pets, such as separate feeding systems, doors, and health monitoring tools. This disjointed approach can lead to inefficiencies and missed opportunities for enhancing pet care. Additionally, in households with multiple pets, it is challenging to manage the individual needs of each pet using these standalone systems. For instance, ensuring that each pet eats the correct amount of food or has access to specific areas of the home can be cumbersome without a unified system.

Furthermore, the existing pet care devices often lack advanced customization and interaction capabilities. Most devices operate on basic programming and do not adapt to the unique behaviors or needs of individual pets. This one-size-fits-all approach fails to provide the optimal care that could be achieved through more personalized interactions.

Another significant challenge is the limitation in remote monitoring and control. While some pet care devices offer remote functionality, their capabilities are often basic and do not provide comprehensive monitoring or control options. Pet owners seeking to manage their pets' care remotely, especially in the context of busy lifestyles or during travel, find these limitations a hindrance.

Moreover, the integration of pet care devices with other home automation systems is typically minimal. This lack of integration can lead to missed opportunities for enhancing pet safety and comfort, particularly in scenarios like emergency situations or environmental changes within the home.

It is within this context that the present invention is provided.

### SUMMARY

The proposed invention seeks to address these gaps in the current pet care technology landscape. By creating a system that centralizes control and interaction among various pet care devices, the invention aims to provide a more integrated, efficient, and personalized approach to pet care.

The present invention relates to a comprehensive pet management system designed to enhance the care and monitoring of pets. The system comprises a smart collar equipped with a rechargeable battery, a wireless communications module, and a controller. This collar is central to the system, functioning as a node that interacts with various peripheral smart pet devices and one or more user devices, such as smartphones.

In some embodiments, the system includes a base station for Real Time Kinematic (RTK) data processing. This base station enhances the GPS capabilities of the smart collar, providing high-resolution location data, which is essential for precise pet tracking and management within the pet management environment.

The smart collar is configured to establish a wireless communication link with multiple peripheral smart pet devices. These devices include, but are not limited to, a smart food bowl, a smart water bowl, a smart pet door, interactive pet toys, a smart litter box, and a smart cage. Each of these devices offers tailored functionalities to the pet, based on stored permissions and authorizations associated with the pet's unique identity.

In some embodiments, the smart food bowl is designed to provide selective feeding functionality, dispensing food based on the specific behaviors of the pet as detected by the smart collar. Additionally, the smart collar can manually control the smart food bowl through a user interface on a mobile app or remote control device.

The smart water bowl, in another embodiment, interacts with the smart collar to control water dispensation based on predefined schedules or detected water levels. The system can also adjust the temperature of the water dispensed by the smart water bowl, considering environmental conditions and the pet's unique identity.

Furthermore, the smart pet door is configured to control access based on time, situational parameters, or pet behavior. It can also provide remote monitoring and control functionalities for the pet owner and can be integrated with home security systems to enhance overall home security.

In another embodiment, the smart collar interacts with interactive pet toys, monitoring and responding to the pet's play behavior. The smart litter box controls access based on the pet's identity and initiates cleaning cycles and odor control after use. The smart cage interfaces with the smart collar to control entry and exit based on pet identity, schedule, or detected emergency situations, and can adjust environmental conditions within the cage for the pet's comfort.

The system further comprises one or more external modules that attach to and exclusively interact with the smart collar. These modules include, but are not limited to, a shock module and a bark control module for training, an LED lights module for visibility, and an environmental sensor module.

Additionally, the invention encompasses a computer-implemented method for managing pet care in the pet management system. This method involves using the smart collar to manage interactions with the peripheral smart pet care devices, processing data inputs related to the pet's interactions, and sending information to the user's computing device for enhanced monitoring and control. The smart collar's programmable controller executes software instructions to analyze the pet's behavior and adjust the operation of the peripheral devices in real-time, thus enhancing pet care and management.

In some embodiments, the method further includes the integration of an RTK base station, enhancing the GPS hardware in the smart collar for improved location tracking and refining the management and monitoring of the pet's interactions within the pet management environment.

### BRIEF DESCRIPTION OF THE DRAWINGS

Various embodiments of the invention are disclosed in the following detailed description and accompanying drawings.

FIG. 1: This figure illustrates a system architecture diagram showing a smart collar in wireless communication with various devices including a user device, an RTK base station, and multiple smart pet care devices.

FIG. 2: This figure presents a process flow diagram outlining a computer-implemented method for managing pet care within a pet management system, detailing interactions between a smart collar, peripheral smart pet care devices, and a user's computing device.

Common reference numerals are used throughout the figures and the detailed description to indicate like elements. One skilled in the art will readily recognize that the above figures are examples and that other architectures, modes of operation, orders of operation, and elements/functions can be provided and implemented without departing from the characteristics and features of the invention, as set forth in the claims.

### DETAILED DESCRIPTION AND PREFERRED EMBODIMENT

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

### Definitions

The terminology used herein is for the purpose of describing particular embodiments only and is not intended to be limiting of the invention.

As used herein, the term “and/or” includes any combinations of one or more of the associated listed items.

As used herein, the singular forms “a,” “an,” and “the” are intended to include the plural forms as well as the singular forms, unless the context clearly indicates otherwise.

It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

As used herein, the term “smart collar” refers to a wearable device for pets that includes technology such as a wireless communications module, a controller, and a rechargeable battery, capable of performing various functions including but not limited to pet identification, data transmission, and interaction with peripheral devices for pet care.

As used herein, “peripheral smart pet devices” are defined as electronic devices designed for pet care that can communicate and interact with the smart collar. These devices include, but are not limited to, smart food bowls, smart water bowls, smart pet doors, interactive pet toys, smart litter boxes, and smart cages.

As used herein, “Real Time Kinematic (RTK) base station” refers to a stationary device used to enhance GPS data accuracy. It communicates with the smart collar to provide improved location tracking capabilities for the pet management system.

### DESCRIPTION OF DRAWINGS

The present invention introduces a comprehensive pet management system, meticulously designed to provide enhanced care and monitoring of pets through a cohesive integration of technology. Central to this system is a smart collar, outfitted with a rechargeable battery, a wireless communications module, and a programmable controller. This collar serves as a central hub within the system, establishing communication and control links with an array of peripheral smart pet devices as well as with user devices such as smartphones.

The invention addresses existing gaps in pet care technology by centralizing control and interaction among a variety of pet care devices, thereby offering an integrated, efficient, and personalized approach to pet care. The smart collar is engineered to communicate wirelessly with multiple peripheral smart pet devices. These devices, including but not limited to a smart food bowl, a smart water bowl, a smart pet door, interactive pet toys, a smart litter box, and a smart cage, are each configured to provide a set of tailored functionalities. These functionalities are based on stored permissions and authorizations, correlating with the unique identity of each pet.

In certain embodiments of the invention, the system incorporates a base station for Real Time Kinematic (RTK) data processing. This base station significantly enhances the GPS capabilities of the smart collar, enabling high-resolution location data vital for precise pet tracking and management. The smart collar's configuration allows for the establishment of a robust wireless communication link with the peripheral smart pet care devices, thereby facilitating a range of functionalities.

For instance, the smart food bowl in the system is designed to offer selective feeding functionality. It dispenses food contingent on the specific behaviours of the pet as detected by the smart collar. The collar also provides the capability for manual control of the smart food bowl through a user interface available on a mobile app or a remote control device. The smart water bowl, another integral component, interacts with the smart collar to control the dispensation of water. This control is based on predefined schedules or water levels detected by the system, and the system is capable of adjusting the temperature of the dispensed water in accordance with environmental conditions and the specific requirements of the pet.

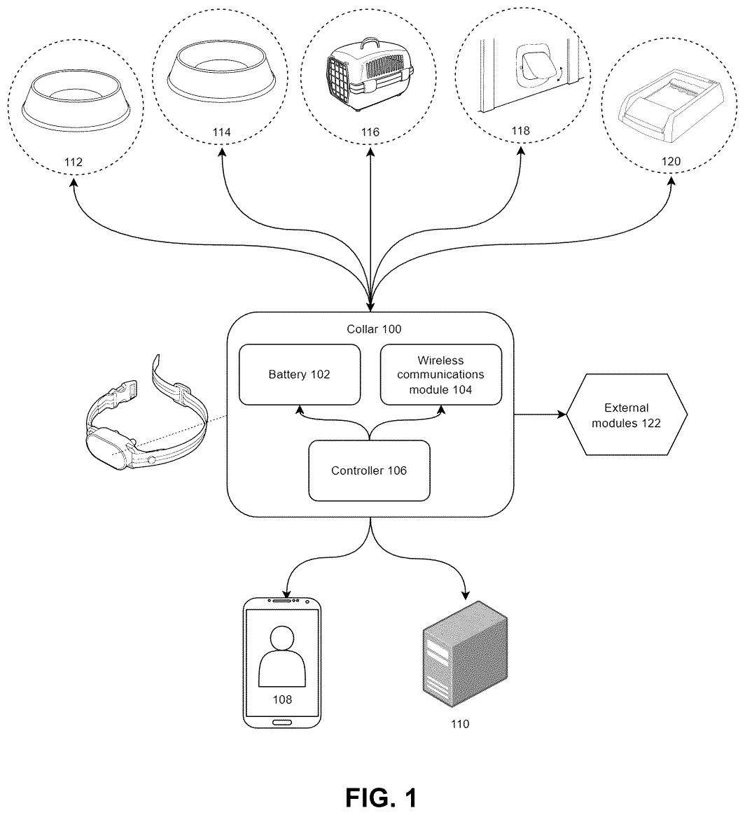

FIG. 1 displays a system architecture diagram showcasing the pet management system. Central to this system is a smart collar 100, equipped with a rechargeable battery 102, a wireless communications module 104, and a controller 106. The smart collar 100 serves as the primary interface for the pet, facilitating communication within the system. The smart collar 100 is configured to establish a wireless connection with a user device 108, such as a smartphone, allowing users to interact and control various aspects of the pet management system. This feature enables pet owners to monitor and manage their pet's care remotely.

An RTK base station 110 is also included in the system to enhance the GPS capabilities of the smart collar 100. The RTK base station 110 communicates with the smart collar 100 to provide high-resolution location data, essential for accurate pet tracking within the pet management environment. The software in the collar 100 processes correction data from the RTK base station 110 to improve GPS accuracy, thereby enhancing pet tracking and management.

The system includes a smart food bowl 112, with which the smart collar 100 interacts. The collar 100 features communication modules capable of using various protocols like RFID, LoRa, Wi-Fi, and cellular networks to interact with the food bowl 112. The embedded software in the collar 100 manages selective feeding based on the pet's unique identity, behaviour-based rewards, and integrates with mobile apps for manual control and automated refill alerts.

A smart water bowl 114 is also part of the system. The smart collar 100, equipped with versatile communication modules, interacts with the water bowl 114 to control water dispensing. This includes managing dispensing schedules, monitoring water intake, adjusting temperatures as needed, and providing remote alert and control capabilities.

In addition, the system encompasses a smart cage 116. The smart collar 100 includes multi-protocol communication modules that interact with the cage's 116 locking mechanisms. The software within the collar 100 controls automated entry/exit, scheduled locking, safety alerts, and remote monitoring. It also manages environmental conditions within the cage 116, ensuring the pet's comfort.

The smart collar 100 further interfaces with a smart pet door 118. The collar 100 contains modules for communication protocols necessary to operate the pet door's 118 locking mechanism. The software in the collar 100 enables access control based on time or situational parameters, behaviour and safety monitoring, and integrates with home security systems for enhanced safety. Remote control and monitoring capabilities are also provided.

A smart litter box 120 is another component of the system. The smart collar 100 uses various communication protocols to control access to the litter box 120. The software in the collar 100 includes functionality for usage monitoring, automatic cleaning, odour control, and remote notification and control features.

Additionally, the system incorporates external modules 122 that interface exclusively with the smart collar 100. These modules, such as a shock module, LED lights, environmental sensors, and a bark control module, utilize multiple communication protocols. The software in the collar 100 controls these modules in response to environmental cues or pet behaviour.

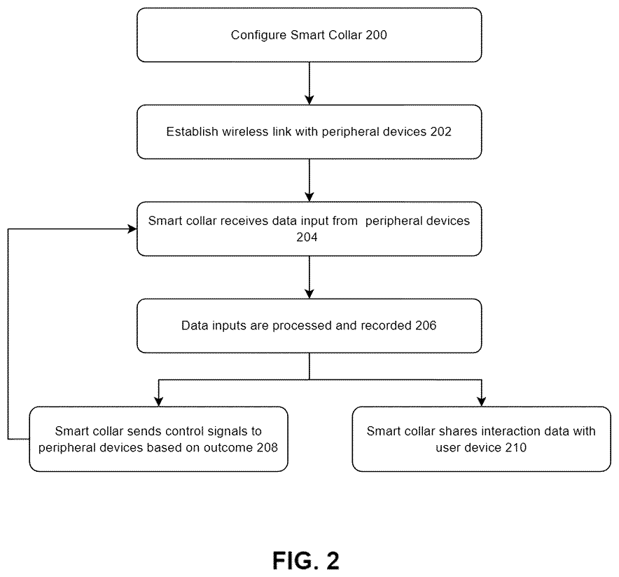

FIG. 2 illustrates a process flow diagram for a computer-implemented method in the context of a pet management system.

The process initiates with providing and configuring a smart collar 200. The smart collar 200 is equipped with advanced hardware, including a wireless communications module and a programmable controller, and is configured to uniquely identify a pet. This identification is crucial for the subsequent interactions within the system.

The next step involves establishing a wireless communication link 202 between the smart collar 200 and a plurality of peripheral smart pet care devices by the smart collar sharing its unique pet identity. These devices, which may include elements like a smart food bowl, smart water bowl, and smart pet door, are capable of receiving signals from and transmitting signals to the smart collar 200, enabling interactive functionalities based on the unique pet identity.

Following the establishment of the communication link 202, the smart collar 200 receives data inputs 204 from sensors embedded in the peripheral devices. For example, sensors in the smart food bowl may transmit data regarding the quantity of food consumed by the pet, while sensors in the smart door may provide information about the pet's movements in and out of the house.

The smart collar 200 then processes 206 these data inputs using its programmable controller. This processing might include analyzing the frequency of the pet's feeding or the pattern of its movements, which could indicate specific needs or behaviors of the pet.

After processing the data inputs 206, the smart collar 200 transmits control signals 208 back to the peripheral devices. These signals are tailored based on the processed data, allowing for dynamic adjustments in the operation of these devices. For instance, if the pet has not eaten, the smart collar 200 may signal the food bowl to dispense more food.

Simultaneously, the smart collar 200 sends information 210 regarding the pet's interactions and activities to the user's computing device. This information allows the pet owner to monitor the pet's health and activities remotely, offering insights into the pet's well-being.

Another part of this system is the RTK base station, which enhances the location-tracking capabilities of the smart collar 200. The base station communicates with the collar to provide precise GPS data, crucial for monitoring the pet's location.

The smart collar 200 processes the correction data received from the RTK base station. This processing involves refining the GPS data to provide more accurate location information of the pet, which can be vital in cases where the pet wanders outside a designated safe zone.

Finally, the method involves utilizing this precise location information in conjunction with the data inputs from the peripheral devices. This comprehensive approach allows for refined management and monitoring of the pet's interactions and behavior within the pet management environment, ensuring that the pet's needs are effectively met.

### Network Components

As utilized in the present invention, a user device may encompass a wide range of electronic devices capable of interfacing with the smart collar and peripheral smart pet devices. These user devices include, but are not limited to, smartphones, tablets, laptops, desktop computers, wearable devices, and other similar computing devices. Each user device is equipped with hardware and software enabling it to receive, process, display, and transmit data within the pet management system.

A wireless communications protocol as referred to herein refers to the set of standards and protocols employed for wireless communication between the smart collar, peripheral smart pet devices, user devices, and any other components of the pet management system. These protocols include, but are not limited to, Bluetooth, Wi-Fi, Zigbee, LoRaWAN, NFC (Near Field Communication), RFID (Radio Frequency Identification), cellular networks (such as 4G LTE, 5G), and other emerging wireless communication technologies. The choice of protocol may depend on factors such as range, data rate, power consumption, and the specific application within the pet management system.

Regarding network architectures, the present invention may operate within various network configurations to facilitate communication and data exchange. This includes local area networks (LAN), wide area networks (WAN), the Internet, intranets, mesh networks, peer-to-peer networks, client-server networks, and cloud-based network architectures. The network architecture may involve the use of servers, routers, gateways, cloud computing platforms, and other network devices and infrastructure to support the seamless and efficient operation of the pet management system.

The user devices, wireless communications protocols, and network architectures mentioned herein are intended to be exemplary rather than limiting and may encompass any suitable types and configurations of devices, protocols, and architectures capable of supporting the functionalities of the pet management system as described in this patent.

As described throughout, a dedicated application software or “app” may be installed on the one or more suer devices to interact with the collar and peripheral devices of the disclosed system. The dedicated application software, as contemplated in the present invention, constitutes a specialized software engineered for deployment on various user devices. This software is designed to facilitate interactive management and control over the smart collar and its associated array of peripheral smart pet devices. The software is meticulously developed to be compatible with multiple operating systems and platforms, such as but not limited to IOS, Android, Windows, macOS, and Linux. This ensures its seamless functionality across a diverse spectrum of user devices, encompassing smartphones, tablets, laptops, and desktop computers. The interface of the application is crafted to be intuitive and user-friendly, incorporating graphical representations and interactive controls, thus offering easy navigation. This design allows pet owners or caregivers to efficiently engage in monitoring and managing the functionalities of the smart collar and its connected peripheral devices.

The functionality of the software spans a broad range, including but not limited to real-time monitoring of the pet's location and activities, administration of feeding schedules, management of water dispensation, and setting of access permissions for pet doors and cages. It also extends to health monitoring and interactive engagement with pet toys and litter boxes, coupled with the capability to customize settings for individual pets. The software establishes communication with the smart collar via various wireless communication protocols, facilitating the transmission and receipt of data, alerts, notifications, and updates that are crucial to the pet's activities and the operational status of the peripheral devices.

In the design of the application, paramount importance is placed on security and privacy. This is achieved by integrating features such as secure login mechanisms, data encryption, and adherence to prevailing privacy regulations, thereby ensuring the protection of sensitive information pertaining to both the pet and the owner. The software is subject to regular updates and support mechanisms aimed at enhancing its functionality, introducing new features, rectifying bugs, and bolstering overall security.

It should be understood that manipulations within the computer are often referred to in terms of adding, comparing, moving, searching, or the like, which are often associated with manual operations performed by a human operator. It is to be understood that no involvement of the human operator may be necessary, or even desirable. The operations described herein are machine operations performed in conjunction with the human operator or user that interacts with the computer or computers.

It should also be understood that the programs, modules, processes, methods, and the like, described herein are but an exemplary implementation and are not related, or limited, to any particular computer, apparatus, or computer language. Rather, various types of general-purpose computing machines or devices may be used with programs constructed in accordance with some of the teachings described herein. In some embodiments, very specific computing machines, with specific functionality, may be required.

### CONCLUSION

Unless otherwise defined, all terms (including technical terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

The disclosed embodiments are illustrative, not restrictive. While specific configurations of the system and methods of the invention have been described in a specific manner referring to the illustrated embodiments, it is understood that the present invention can be applied to a wide variety of solutions which fit within the scope and spirit of the claims. There are many alternative ways of implementing the invention.

It is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A pet management system, comprising:
a smart collar for a pet, the smart collar including:
a rechargeable battery,
a wireless communications module, and
a controller;
one or more user devices; and
one or more peripheral smart pet devices, each being configured to provide access to a set of tailored functionalities to a designated pet having an associated pet identity, based on a set of stored permissions and authorizations associated with the pet identity;
wherein the controller of the smart collar is configured to detect and provide a stored unique pet identity to the one or more peripheral smart pet devices to gain access to the set of tailored functionalities for the pet identity; and
wherein the controller of the smart collar is configured to continuously monitor and track the pet's interactions with the one or more peripheral smart pet devices and maintain wireless communication with the one or more user devices.

2. The pet management system of claim 1, wherein the system further comprises a base station for Real Time Kinematic (RTK) data processing, configured to communicate with the smart collar to enhance the resolution of GPS data for the smart collar or multiple collars.

3. The pet management system of claim 1, wherein the peripheral smart pet devices include at least a smart food bowl, and the smart collar is configured to communicate with the smart food bowl to enable selective feeding functionality based on the pet identity of the collar.

4. The pet management system of claim 3, wherein the smart food bowl is further configured to dispense food based on specific behaviors of the pet as detected by the smart collar, enabling behavior-based feeding based on the pet identity of the collar.

5. The pet management system of claim 3, wherein the smart collar includes functionality for manual remote control of the smart food bowl through a user interface on a mobile app or remote control device.

6. The pet management system of claim 1, wherein the peripheral smart pet devices include at least a smart water bowl, and the smart collar interacts with the smart water bowl to control the dispensing of water based on predefined schedules or detected water levels, and to restrict access to water based on the pet identity of the collar.

7. The pet management system of claim 5, wherein the smart collar is further configured to adjust the temperature of the water dispensed by the smart water bowl based on environmental conditions and the pet identity of the collar.

8. The pet management system of claim 1, wherein the peripheral smart pet devices include at least a smart pet door, and the smart collar is configured to interface with the smart pet door to control access based on time, situation, or pet behavior, and the pet identity.

9. The pet management system of claim 7, wherein the smart pet collar is further configured to interact with the smart pet door to provide remote monitoring and control functionalities for the pet owner.

10. The pet management system of claim 7, wherein the smart pet door is integrated with home security systems, allowing for automatic locking or unlocking in response to the security status of the home.

11. The pet management system of claim 1, wherein the peripheral smart pet devices include at least one interactive pet toy, and the smart collar is configured to interact with interactive pet toys to monitor and respond to the pet's play behavior, tracking frequency and intensity of play.

12. The pet management system of claim 1, wherein the peripheral smart pet devices include at least a smart litter box that interacts with the smart collar to control access based on the pet identity of the collar and to initiate cleaning cycles and odor control after use.

13. The pet management system of claim 1, wherein the peripheral smart pet devices include at least a smart cage, and wherein the smart collar interfaces with the smart cage to control entry and exit based on pet identity, schedule, or detected emergency situations, and to adjust environmental conditions within the cage.

14. The pet management system of claim 1, further comprising one or more external modules that attach to and interact exclusively with the smart collar, selected from the group of: a shock module and a bark control module for training; an LED lights module for visibility, an environmental sensor module.

15. A computer-implemented method for managing pet care in a pet management system, the method comprising:
providing a smart collar equipped with a wireless communications module and a programmable controller for a pet, the smart collar configured to uniquely identify the pet and to communicate with a user's computing device;
establishing a wireless communication link between the smart collar and one or more of a plurality of peripheral smart pet care devices within a pet management environment, each peripheral device capable of interacting with the smart collar based on the unique identification of the pet;
receiving, at the smart collar, data inputs from sensors embedded in the peripheral smart pet care devices, the data inputs related to the pet's interaction with the devices;
processing the received data inputs using the programmable controller of the smart collar to determine actions corresponding to the pet's interaction with the peripheral smart pet care devices;
transmitting control signals from the smart collar to the peripheral smart pet care devices to manage access, operation, or functionality of the devices based on the determined actions;
sending information related to the pet's interactions with the peripheral smart pet care devices from the smart collar to the user's computing device for monitoring and control by a user;
wherein the smart collar programmable controller executes software instructions to analyze the pet's behavior and needs based on the interactions with the peripheral smart pet care devices, and to adjust the operation of these devices in real-time to enhance pet care and management.

16. The computer-implemented method of claim 15, further comprising:
incorporating an RTK (Real Time Kinematic) base station into the pet management system, the RTK base station equipped with hardware to communicate with the smart collar;
enhancing the GPS hardware in the smart collar to be compatible with RTK base station communication for receiving correction data to improve GPS accuracy;
processing, by the smart collar's programmable controller, the correction data received from the RTK base station to relay precise location information of the pet;
utilizing the precise location information from the smart collar in conjunction with the data inputs from the peripheral smart pet care devices to refine the management and monitoring of the pet's interactions and behavior within the pet management environment.
